(19) United States
(12) Patent Application Publication
(10) Pub. No.: US 2006/0021208 A1
(43) Pub. Date: Feb. 2, 2006

(54) Method for fastening a tool in a tool chuck

(75) Inventors: Christian Pfau, Bietigheim-Bissingen (DE); Christoph Zoller, Shanghai (CN)

Correspondence Address: LERNER AND GREENBERG, PA, P O BOX 2480, HOLLYWOOD, FL, 33022-2480, US

(73) Assignee: ZOLLER GMBH & CO. KG

(21) Appl. No.: 10/532,181

(22) PCT Filed: Oct. 20, 2003
(86) PCT No.: PCT/EP03/11593

§ 371 Date: May 19, 2005

(30) Foreign Application Priority Data
Oct. 21, 2002 (DE) 102 49 072.4

(51) Int. Cl. B23P 11/02

(52) U.S. Cl. 29/447; 29/407.05; 279/102

(57) ABSTRACT

The invention relates to a method for fastening a tool (22) within a tool chuck (20). An actual position of the tool (22), especially in the direction of the longitudinal axis of the tool (22), is determined by taking a measurement, whereupon the tool (22) is inserted into the tool chuck (20) and is placed therein based on the determined actual position and is shrunk. The actual position of the tool (22) within the tool chuck (20) is determined following the shrinking process.

### PRIOR ART

The invention relates to a method of fastening a tool in a tool chuck.

Methods for the frictional clamping of shank-type tools, in particular cutting tools, in corresponding tool chucks for mounting in CNC machine tools are known. In one of these known methods, the “shrink fitting” of a tool in a tool chuck, a tool receptacle around a mounting opening of the chuck, for example a cylindrical mounting bore, is heated with hot air or by means of induction currents, so that the tool receptacle around the mounting bore expands. The enlargement of the mounting bore brought about by this enables the tool to be inserted, a frictional bond between shank and tool receptacle being produced immediately after the tool receptacle has cooled down.

In addition, methods are known in which the tool is measured with regard to the actual position of one or more cutting edges of the tool, and the tool is positioned in a tool chuck for clamping in place on the basis of the measurement data.

The object of the invention is to specify a method in which it is ensured with a high degree of certainty that a tool is clamped in place in a tool chuck in an especially reliable and exact manner.

This object is achieved by a method having the features of patent claim 1. Further configurations follow from the subclaims.

### ADVANTAGES OF THE INVENTION

The invention is based on a method of fastening a tool in a tool chuck. It is proposed that an actual position of the tool, in particular in the direction of the longitudinal axis of the tool, be determined by measurement, that the tool then be inserted into the tool chuck and that it be positioned there on the basis of the actual position determined and that it then be shrunk in place, and that the actual position of the tool in the tool chuck be determined after the shrink fitting.

With the method according to the invention, the actual position of the tool in the tool chuck can be checked, for example by comparing the actual position with a desired position. Any deviations from the desired position can be detected and documented in order to obtain highly precise machining results during subsequent machining of a workpiece with the tool by the deviations being taken into account when the tool is being guided in the workpiece. It is also possible to detect errors occurring during the shrink-fitting method. For example, if it has not been possible to insert the tool into the tool receptacle of the tool chuck without touching the tool chuck and if the actual position of the tool has been unintentionally changed in the process, this error is detected before the tool is used and can be corrected. Furthermore, it is possible to detect defects in the tool or in the tool chuck, such as cracks, fractures or material fatigue, and to make a subsequent machining operation of the tool more reliable. Finally, movements of the tool in the tool chuck caused by temperature fluctuations can be determined. In the course of the shrink-fitting operation, the tool chuck is heated and cooled down again to a greater extent. Due to expansion and contraction of the material of the tool chuck, the tool clamped in place in the tool chuck is subjected to a not inconsiderable temperature-induced movement. Thermal irregularities, such as excessive heating of the tool chuck for example, may therefore lead to a deviation of the actual position of the tool from its desired position. Such deviations are reliably detected by the method according to the invention and can be taken into account in a subsequent machining operation.

The actual position of the tool in the tool chuck may be determined by a mechanical measurement, that is to say by measuring by contact of the tool and of the tool chuck with a measuring means. However, it is preferred to determine the actual position in a non-contact manner, in particular by means of a measuring apparatus having an optical system. The measuring apparatus normally comprises a camera and an evaluating unit which evaluates images detected with the camera and determines the actual position of the tool by means of predetermined calculation methods. With such an apparatus, accurate measurements can be carried out in a simple and effective manner. Damage caused by contact between the tool and the measuring apparatus can be reliably avoided.

The actual position of the tool is expediently determined via the actual position of a characteristic element of the tool, for example a cutting edge, a corner or edge or a tip. The actual position of the tool is deduced from the actual position of the characteristic element, or the actual position of the characteristic element is itself regarded as the actual position of the tool. In this case, the actual position of the characteristic element can be determined or checked in the direction in which the tool is inserted into the tool receptacle and/or in the radial direction relative to the rotation axis of the tool. The determination of the actual position of the tool in the direction of insertion enables the correct positioning of the tool in the tool chuck to be checked. The determination of the actual position of the tool in the radial direction enables the concentricity of the tool to be checked and can detect temperature-induced movements and in particular defects in the tool or in the tool chuck.

According to a preferred embodiment of the method according to the invention, the actual position of the tool is monitored during the insertion of the tool into the tool chuck. In this way, unintentional movement of the tool during the insertion, displacement in the tool gripper or canting in the tool chuck can be detected. When the actual position of the tool is being monitored during the insertion, the characteristic element of the tool is expediently freely accessible, so that the monitoring can be effected by means of an optical sensor.

According to a preferred embodiment of the method according to the invention, the actual position is determined in the axial direction and radial direction of the tool after the shrink fitting. In this way, both the actual position in the insertion direction of the tool and unbalance in the radial direction can be determined with great accuracy. If the unbalance is exceeded, that is to say if a tool is clamped in place obliquely beyond a specific value with regard to the insertion direction or axial direction, the process for shrinking the tool in place in the tool chuck can be repeated.

The actual position of the tool is expediently defined with regard to a reference point on the tool chuck. The reference point can be determined using an optical system. In numerous applications, however, it may be assumed that the reference point is arranged in an accurate position by the fastening of the tool chuck in a tool-mounting spindle, so that no further measurement of the reference point is required.

During the shrink fitting, the tool is preferably held by a tool gripper which has also held the tool during the measuring. In this way, the risk of a positioning error can be reduced. The tool gripper is expediently able to rotate the tool about its rotation axis so that the tool can be rotated during the measuring and an envelope curve, for example, can be determined.

The tool chuck is advantageously fastened in a spindle during the shrink fitting and is not removed from the spindle until after the actual position has been determined. By the actual position being determined immediately after the shrink fitting, an error can be detected immediately. In addition, the actual position determined in this way can be compared with a subsequently determined actual position, for example after the tool chuck has cooled down, and the reliability of the clamping operation can thus be increased.

In an expedient configuration of the invention, the position is determined after the tool chuck has cooled down below a desired temperature. This ensures that the tool in the tool chuck is no longer subjected to any temperature-induced movement after the position has been determined. Thus that actual position of the tool in the tool chuck which the tool also assumes during a subsequent machining operation can be determined.

A number of tools are advantageously shrunk in place in a respective associated tool chuck and are deposited together with the tool chuck in a loading and unloading magazine, and then the actual position of the tools in the tool chucks is determined. In this way, a number of tools can first be shrunk in place in associated tool chucks and then the tools, after a cooling process, can then be clamped in place again with the tool chuck in a mounting spindle and checked for their position. The mounting spindle can thus already be used during the cooling of a tool chuck for shrinking a next tool in place in another tool chuck.

In a further embodiment of the invention, the tool in the tool chuck is located in a desired position in the tool chuck before the shrink fitting. The desired position is adapted to a subsequent machining process and possibly relates to a distance between a reference point and a significant element of the tool.

Alternatively, the tool is expediently positioned in the tool chuck at a distance from the desired position corresponding to a correction size. Due to the cooling of the tool chuck after the insertion of the tool, the tool firmly enclosed by the tool chuck is moved by a small distance normally in the direction of the rotation axis of the tool. If need be, this movement caused by the thermal contraction of the tool chuck can be completely compensated for by the correction size, so that the tool is located in the desired position after the cooling of the tool chuck.

To determine the correction size, which depends on the degree of heating of the tool chuck during the shrink-fitting process, it is advantageous for the temperature of the tool chuck to be monitored before the positioning of the tool. In addition, due to this monitoring, the temperature of the tool chuck can be set precisely so low that the tool, under low thermal loading of the tool chuck, can just be inserted correctly into the mounting opening.

Simple and quick data transfer to a machine tool can be achieved by the actual position being written to a data carrier, connected to the tool chuck, after the position has been determined. The data carrier may be a chip which can be thermally loaded and which is integrated, for example, in or on the tool chuck. When the tool chuck with the tool shrunk in place is put into the machine tool, the data can be quickly read out in an especially simple manner and can be reliably associated with the tool chuck.

### DRAWING

Further advantages follow from the description below of the drawing. An exemplary embodiment of the invention is shown in the drawing. The drawing, the description and the claims contain numerous features in combination. The person skilled in the art will also expediently consider the features individually and form appropriate further combinations therefrom.

In the Drawing:

FIG. 1 shows the construction of a preferred apparatus for carrying out the method according to the invention, in a schematic side view,

FIG. 2 shows a side view of a tool to be shrunk in place,

FIG. 3 shows a side view of a tool chuck,

FIG. 4 shows a side sectional view of a complete tool formed from a tool chuck and a tool shrunk in place.

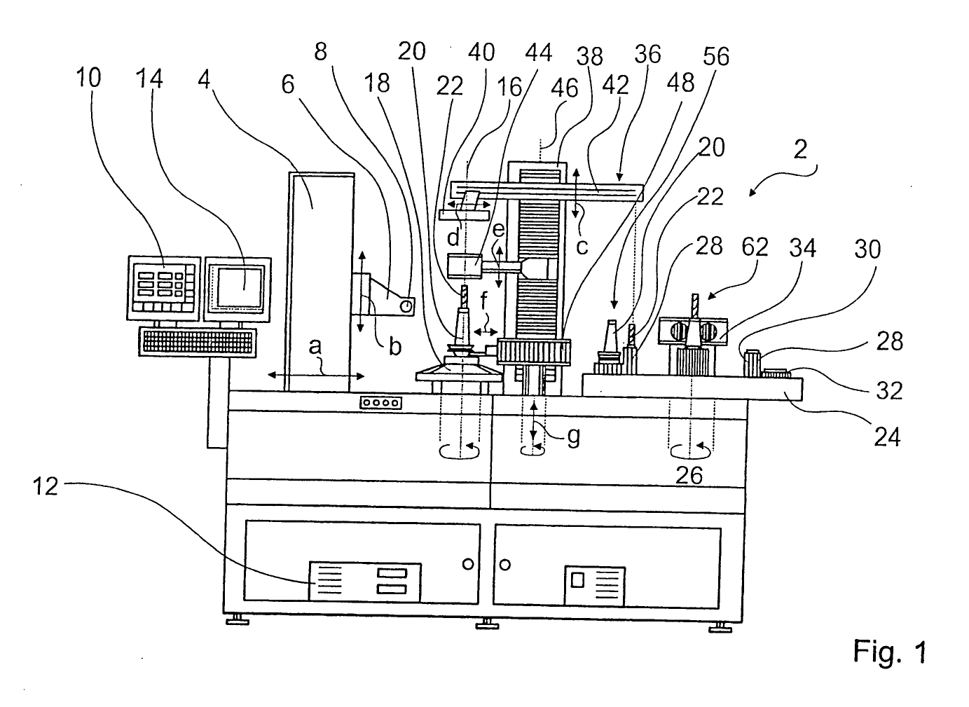

The setting and measuring arrangement 2 shown in FIG. 1 has a slide 4 which is traversable in the direction of double arrow a and on which an optical-system carrier 6 is traversable in the direction of double arrow b. The optical-system carrier 6 carries a camera or an optical measuring system 8, which preferably works by the transmitted-light method. The setting and measuring arrangement 2 is operated by means of an operating unit 10. The operating unit 10 preferably has a computing unit 12 with means for image processing. A tool to be measured can preferably be shown on a monitor 14.

A CNC-controlled tool-mounting spindle 18 rotatable about a rotation axis 16 serves to mount a tool chuck 20, into which a tool 22 to be shrunk in place can be inserted. A loading and unloading magazine 24 designed as a turret is designed to be rotatable about a rotation axis 26 and carries a number of loading and unloading stations 28, which each comprise a tool receptacle 30 and a receptacle 32 for a tool chuck 20. In addition, the loading and unloading station 28 is equipped with a cooling unit 34, into which the complete tool formed from the tool chuck 20 and the tool 22 can be inserted after the shrink fitting.

Furthermore, the setting and measuring arrangement 2 has a CNC-controlled and/or pneumatically controlled feeder unit 36 with a vertical slide 38. This vertical slide 38 carries a tool gripper 40 on a cross slide 42 and an induction coil 44. The cross slide 42 is displaceable in the direction of double arrow c, and the tool gripper 40 attached thereto is displaceable in the direction of double arrow d. Furthermore, the tool gripper 40 is designed to be rotatable about the rotation axis 16. The induction coil 44 is displaceable in the direction of double arrow e, it also being conceivable to additionally design it in the direction of double arrow f and/or so as to be rotatable about an axis 16.

The feeder unit 36 has a tool-chuck changer 48 for transferring tool chucks 20 from the loading and unloading magazine 24 to the tool-mounting spindle 18 and vice versa. The tool-chuck changer 48 is rotatable about the axis 46 and traversable in the direction of double arrow g parallel to the axis 46.

The way in which a preferred embodiment of the method according to the invention is carried out is described in more detail below with reference to the apparatus according to FIG. 1 explained above.

First of all a tool 22 is put into a mounting sleeve, after which these two parts are put into a corresponding receptacle of the loading and unloading station 28. Accordingly, a tool chuck 20 is inserted into a corresponding receptacle of the loading and unloading station 28. In addition, the identification number of the tool 22 and/or data of the tool 22, such as desired sizes, shrink-fitting time, shank diameter, etc., is input into the computing unit 12 manually or automatically from a database. When the shrink-fitting sequence is started by means of corresponding control of the computing unit 12, the loading and unloading magazine 24 is rotated automatically about its rotation axis 26, so that the tool chuck 20 and the tool 22 pass into a removal position 56. The tool-chuck changer 48 removes the tool chuck 20 and inserts it into the tool-mounting spindle 18 by means of a rotation about the axis 46. A tool-clamping device integrated in the tool-mounting spindle 18 is automatically switched on and fixes the tool chuck 20 in the tool-mounting spindle 18 in a power-operated manner.

The tool gripper 40 now travels along the cross slide 42 and, by means of a vertical displacement of the cross slide 42, to the tool 22 and removes it from the mounting sleeve. The tool 22 is moved by means of the tool gripper 40 in a CNC-controlled manner into a waiting position above the clamped tool chuck 20 concentrically with respect to the rotation axis 16.

To first determine the actual position of the tool 22, the slide 4 and the optical-system carrier 6 are now moved in such a way that the optical measuring system 8 passes into the region of a cutting edge 58 of the tool 22 to be measured, this cutting edge 58 being measured as a characteristic element of the tool 22. In the event of the desired dimensions of the cutting edge 58 not being known, provision is expediently made for an automatic search run to be carried out by means of the optical measuring system 8. As soon as the cutting edge 58 is in the field of vision of the optical measuring system 8, the tool gripper 40 starts to rotate the tool 22 about the rotation axis 16 in a CNC-controlled manner in order to optically focus the cutting edge 58. Once that has been done, the actual position of the cutting edge 58, and in particular the actual position of the cutting tip, along the longitudinal axis is determined with microaccuracy. With the longitudinal dimensions of the tool 22 which are thus provided, or with the actual positioning of the cutting edge 58 and cutting tip, the traverse path along the rotation axis 16 for the tool gripper 40 for achieving the essential desired dimension for the tool 22, in particular with regard to the tool chuck 20 or the tool-mounting spindle 18, is known.

The induction coil 44 is now positioned around the tool-mounting spindle 18 and switched on, and the tool chuck 20 is heated and expands. The temperature of the tool chuck 20 is monitored by means of a sensor (not shown in any more detail). When a desired temperature is reached, the induction coil 44 is moved away in such a way that the tool 22 can then travel downward and a shank 60 of the tool 22 is inserted into the tool chuck 20. During this traveling into position, the cutting edge 58 of the tool 22 is constantly tracked and measured by means of the optical measuring system 8 by appropriate displacements of the slide 4. If changes in the positioning, for example on account of an unintentional displacement of the tool 22 inside the tool gripper 40, are detected, the complete fastening operation can be aborted and the tool 22 can be put back again automatically into the loading and unloading magazine 24 and identified accordingly.

If the desired size, which can be determined on the basis of the longitudinal measurement of the tool 22 and is designated in FIG. 4 by L_{G}, plus a correction size taking into account the thermal expansion of the tool chuck 2 has been achieved, the tool gripper 40 which holds the tool 22 is stopped in its current position. The tool 22 is now at a distance from its desired position corresponding to the correction size. After cooling of the tool chuck 20, for example after a few seconds, the tool gripper 40 releases the tool 22, and the shrink-fitting operation is ended. The tool gripper 40 is traversed upward, for example into a waiting position.

The actual position of the tool 22 in the tool chuck 20 is now determined by the optical measuring system 8 measuring the cutting edge 58 of the tool 22 for its actual position with regard to a reference point 64 (FIG. 4). The actual position and possibly further measuring data are written on a temperature-resistant chip fastened to the tool chuck 20. The tool-clamping device with which the tool chuck 20 is fixed in the tool-mounting spindle 18 is now released. The tool-chuck changer 48 removes the complete tool consisting of tool chuck 20 and tool 22 and puts it into an available loading and unloading station 28 of the loading and unloading magazine 24. By rotation or another suitable movement, the complete tool is positioned in front of or in a cooling station 62.

In addition to a space for the complete tool, the cooling station comprises a plurality of cooling bells, which are each designed for different tool diameters. The cooling bell of suitable size is selected and slipped over the tool chuck. After sufficient and monitored cooling, for example by an infrared inductor (not shown in the figures), the complete tool travels to a waiting position. Further tools 22 located in the loading and unloading unit 24 can be shrunk in place in an associated tool chuck 20, cooled and put into a waiting position as described above.

If all the complete tools or a desired number of complete tools have been shrunk, one of the complete tools located in the loading and unloading magazine 24 is put into the tool-mounting spindle 18 by means of the tool-chuck changer 48 and is clamped in place there. The actual position of the tool 22 is then determined once again by the optical measuring system 8, to be precise with regard to the direction of insertion of the tool 22 into the tool receptacle 66 of the tool chuck 20, that is to say in the perpendicular direction. The measuring results and/or the distance of the cutting edge 58 or of another characteristic element of the tool 22 from the reference point 64 are/is stored on the chip. In addition, the tool is rotated by at least one full revolution about the rotation axis 16 by rotation of the tool-mounting spindle 18, in the course of which the computing unit 12 determines from the measurements of the optical measuring system 8 an envelope curve of the cutting edges 58 of the tool 22 and from that the actual position of the tool 22 in the radial direction. The corresponding data are written to the chip. If the values determined do not correspond to a tolerance band stored in the computing unit 12, the complete tool is identified on the chip as defective. After the determination of the position has been completed, the complete tool is put down again in the loading and unloading magazine 24 by the tool-chuck changer 48. A further complete tool can be checked for the actual position of the tool 22. In this efficient manner, all the tools or a desired number of tools can first be shrunk and cooled and then measured as complete tools.

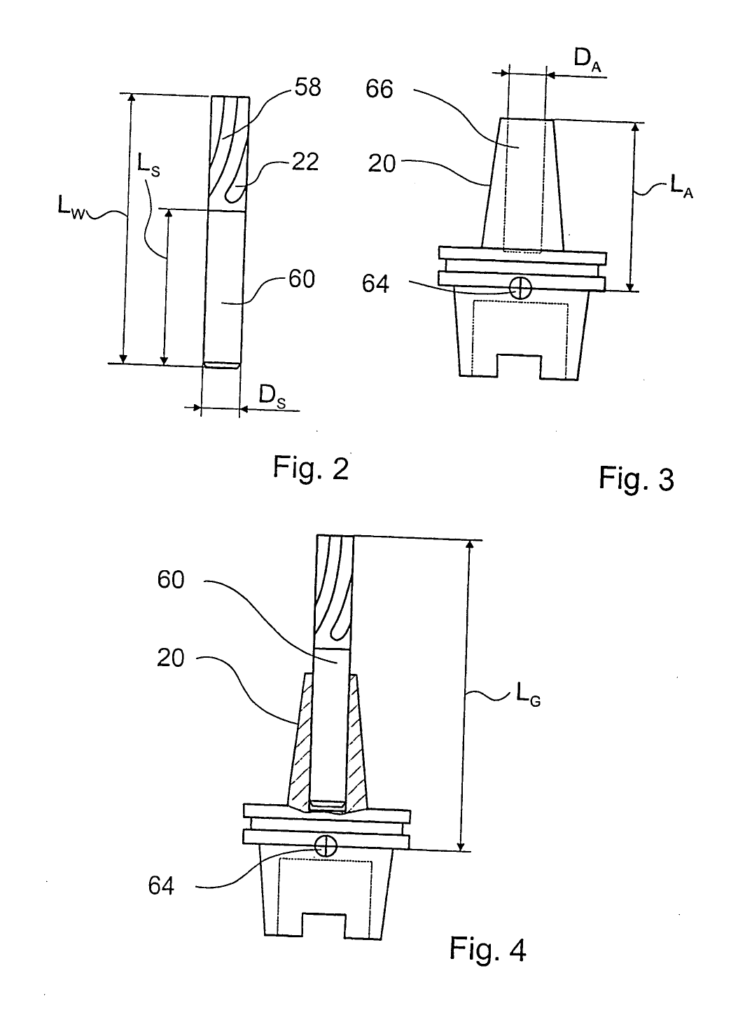

For further explanation of lengths and details which cannot be seen in FIG. 1, reference may be made to FIGS. 2, 3 and 4. FIG. 2 shows a tool 22 which is to be inserted into a tool chuck 20 as shown in FIG. 3. The tool 22 has a total length L_{W} and a shank length L_{S}. The maximum diameter of the tool 22 is designated by D_{S}. The tool chuck 20 has an insertion bore 18a having a diameter D_{A}. The tool chuck 20 has a tool receptacle 66 and, in accordance with the design of the machine tool used, is formed with a steep-taper or a hollow-taper shank. The vertical length of the tool chuck 20 from a reference point 64 is designated by L_{A}. The desired position of the tool 22 inserted into the tool chuck 20 is expediently set relative to this reference point 64. For this purpose, it may be appropriate to also detect the position of the reference point 64 by means of the optical measuring system 8. These facts are shown in FIG. 4, in which a shrunk complete tool formed from the tool chuck 20 and the tool 22 is shown. It can be seen that the desired length L_{G} of this complete tool is defined relative to the reference point 64. The reference point 64 expediently corresponds to the plane-parallel position of the tool chuck 20 in the tool-mounting spindle 18, so that it is possible to assume that the precise position of the reference point 64 is known, so that optical detection can be dispensed with.

Designations

2 Setting and measuring arrangement
4 Slide
6 Optical-system carrier
8 Optical measuring system
10 Operating unit
12 Computing unit
14 Monitor
16 Rotation axis
18 Tool-mounting spindle
20 Tool chuck
22 Tool
24 Loading and unloading magazine
26 Rotation axis
28 Loading and unloading station
30 Tool receptacle
32 Receptacle
34 Cooling unit
36 Feeder unit
38 Vertical slide
40 Tool gripper
42 Cross slide
44 Induction coil
46 Axis
48 Tool-chuck changer
56 Removal position
58 Cutting edge
60 Shank
62 Cooling station
64 Reference point
66 Tool receptacle
L_{A} Reference point
L_{G} Desired size
L_{W} Total length
L_{S} Shank length
D_{A} diameter
D_{S} diameter of the tool

1-23. (canceled)

24. A method of fastening a tool in a tool chuck, which comprises the steps of:
determining by measurement an actual position of the tool;
inserting the tool into the tool chuck;
positioning the tool in the tool chuck on a basis of the actual position previously determined;
shrink fitting the tool in place; and
determining an actual position of the tool in the tool chuck after the shrink fitting step.

25. The method according to claim 24, which further comprises monitoring the actual position of the tool during the inserting step for inserting the tool into the tool chuck.

26. The method according to claim 24, which further comprises during the shrink fitting step, holding the tool with a tool gripper which also held the tool during the measurement.

27. The method according to claim 24, which further comprises fastening the tool chuck in a spindle during the shrink fitting step and not removing the tool chuck from the spindle until after the actual position of the tool in the tool chuck has been determined.

28. The method according to claim 24, which further comprises:
shrinking a number of tools in place in a respectively associated tool chuck;
depositing the tools with the tool chucks in a loading and unloading magazine; and
determining the actual position of the tools in the tool chucks.

29. The method according to claim 24, which further comprises positioning the tool in the tool chuck at a distance from a desired position corresponding to a correction size.

30. The method according to claim 24, which further comprises writing the actual position to a data carrier connected to the tool chuck, after the actual position has been determined.

31. The method according to claim 24, which further comprises determining a traverse path for moving the tool from the actual position determined into the tool chuck from the actual position.

32. The method according to claim 24, which further comprises determining the actual position in a non-contact manner.

33. The method according to claim 24, which further comprises determining the actual position in regards to an element of the tool selected from the group consisting of a cutting edge, a corner, an edge and a tip.

34. The method according to claim 24, which further comprises defining the actual position of the tool with regard to a reference point on the tool chuck.

35. The method according to claim 24, which further comprises rotating the tool, before a determination of the actual position, about a rotation axis outside the tool chuck in front of an optical measuring system.

36. The method according to claim 24, which further comprises holding the tool with a tool gripper during the measurement.

37. The method according to claim 36, which further comprises holding the tool, for the measurement, concentrically to a rotation axis of a spindle.

38. The method according to claim 36, which further comprises using the tool gripper to rotate the tool about its rotation axis.

39. The method according to claim 24, which further comprises determining the actual position in a radial direction relative to a tool axis after the shrink fitting step.

40. The method according to claim 24, which further comprises detecting an unintentional movement of the tool during the inserting step.

41. The method according to claim 24, which further comprises determining the actual position immediately after the shrink fitting step.

42. The method according to claim 41, which further comprises comparing the actual position determined immediately after the shrink fitting step with a subsequently determined actual position after the tool chuck has cooled down.

43. The method according to claim 24, which further comprises heating the tool chuck during the shrink fitting step and a temperature of the tool chuck is monitored by a sensor before the positioning of the tool.

44. The method according to claim 24, which further comprises mounting the tool chuck in a spindle rotatable about a rotation axis.

45. The method according to claim 28, which further comprises configuring the loading and unloading magazine to be rotatable about a rotation axis.

46. The method according to claim 28, which further comprises positioning the tool in front of or in a cooling station by rotation of the loading and unloading magazine.

47. The method according to claim 24, which further comprises determining the actual position of the tool in a direction of a longitudinal axis of the tool.
